(19) United States
(12) Patent Application Publication
(10) Pub. No.: US 2009/0304463 A1
(43) Pub. Date: Dec. 10, 2009

(54) POWDER HANDLING DEVICE

(75) Inventors: Jeffery Robert Dance, Hamilton (NZ); Richard John Miles, Hamilton (NZ)

Correspondence Address: KNOBBE MARTENS OLSON & BEAR LLP, 2040 MAIN STREET, FOURTEENTH FLOOR, IRVINE, CA, 92614, US

(73) Assignee: Powder Projects Limited, Hamilton (NZ)

(21) Appl. No.: 12/063,648

(22) PCT Filed: Aug. 11, 2006
(86) PCT No.: PCT/NZ2006/000204

§ 371 Date: Jul. 29, 2008

(30) Foreign Application Priority Data
Aug. 12, 2005 (NZ) 540013

(51) Int. Cl. B65G 53/40; B65G 53/52

(52) U.S. Cl. 406/122; 406/195

(57) ABSTRACT

A method for releasing flowable material via an automated means from a receptacle which has at least one closed end, characterised by the steps of locating the receptacle in a defined position relative to a receptacle opening mechanism, and opening the receptacle with the receptacle opening mechanism, the method characterised in that the receptacle is positioned such that it is opened substantially below the bulk of the material in the receptacle. Also disclosed is a method of releasing flowable material via an automated means from a receptacle which has at least one closed end, characterised by the steps of locating the receptacle in a defined position relative to a receptacle opening mechanism, and opening the receptacle with the receptacle opening mechanism, the method characterised in that the flowable material within the receptacle is fluidised.

### TECHNICAL FIELD

This invention relates to a device for emptying bags of powder.

### BACKGROUND ART

Many companies and industries make use of particulate matter which is usually supplied in bags of volumes which range from 25 kilograms to 50 kilograms.

One main industry which uses a large number of bags containing particulate matter (specifically powdered material) is the dairy industry. An estimated fifty million, twenty five kilogram bags of milk powder or milk powder derivatives are exported from New Zealand annually.

Similarly large numbers of bags are transported around New Zealand. This leads to a large number of bags which have to be opened and emptied before the material can be used.

Most existing or conventional methods for emptying bags of powdered material involve a large amount of manual labour. This varies on the type of bag which is used, however in most instances it involves a person lifting a bag off a pallet, removing the outer Kraft paper from the bag (bags with an inner layer of plastic and an outer layer of Kraft paper are very common, especially in the diary industry and movement of milk powder from one location to another), and conveying the plastic bag without the Kraft paper to a bag tipping station.

Bags of powdered material are usually emptied into a square or round conical stainless steel receptacle. This may, or may not have a dust extraction system fitted to it for operator comfort, and prevent loss of the powdered material. It also has a means attached to the bottom for drawing away the powder to further processing or storage devices.

Firstly the bag of powdered material is positioned manually in a horizontal position over the tipping station. The person then cuts the bag, which can either be the plastic pouch of a bag which has had an outer layer of Kraft paper removed, or the entire bag. Including the outer Kraft paper. The bag is cut with a knife in one or more positions, or one end of the bag is cut open or sliced off. The bag is then manually moved around as required to empty its contents. When it is empty, the plastic liner or bag is discarded to a collection receptacle for disposal.

As well as being time consuming, one major disadvantage of this method is that the operator may come into contact with the powdered material. This is a significant problem for sanitary reasons as contact between the powdered material and the operator or external environments can create bacterial and foreign contamination problems.

During emptying of the powder material from the bag, the operator will try to avoid contacting the powder inside the bag. However when done manually this can be difficult and it is impossible to guarantee that skin contact will not be made with the powder.

Even the handler wearing gloves to prevent skin contact with the powder may not overcome this problem. As most areas where bags are emptied are open during the tipping process, it is possible for contaminants to enter the system from areas of the operator other than their hands, such as hairs from the arm or head or body fluid such as perspiration or nasal droplets from sneezing.

Other contamination from the environment can also occur. These contaminants may include old powder from previous use of the tipping station due to inadequate cleaning, broken knife blades, or parts thereof from cutting open the bags, or bacterial or other matter in the air/environment.

Manually emptying bags of powdered material can also result in decreased yield, due to powder being left behind in pockets or comers of the bag. This may especially be the case if the operator is careless during the emptying process. If the powder is of high value as is the case with dairy powders, or a large number of bags are being emptied in a careless manner, this can lead to a considerably decreased yield. The long term results may be increased costs or decreased profits for the company.

There are other systems for emptying bags in existence.

These systems make use of a method whereby the bag is positioned manually above and conveyed horizontally across one or more rotary knives, which make a number of incisions into the horizontal side of the bag. These incisions allow the powder to discharge.

One significant disadvantage of this method is that the rotating knives are indiscriminate in terms of cutting the bags. This may lead to shreds of plastic (or other material the bag is made of) finding their way into the product or other machinery. This is generally not acceptable in terms of hygiene and product safety within the dairy, or other industries.

WO 2004052727 discloses a bag cutter apparatus for discharging the contents of a container characterised by the container locating means being adapted in one orientation to support the container and being adapted in another orientation to prevent the discharge of contents.

However, the disadvantage of this system is that it does not include a mechanism for fluidising the contents of the container to allow easier removal of material. Also, it contains only spikes to hold the container in place. Not only is this unhygienic, but once the contents are removed from the container, this can cause the container to bunch up.

This device also contains a hinge mechanism that allows the material to flow out from both sides of the container which makes it difficult to control the flow of material.

U.S. Pat. No. 6,293,318 is an invention that relates to an emptying station suited for emptying contents from bulk bags. The emptying station includes a bulk-bag receptacle body having a top opening and bottom outlet, a bulk-bag cutting subassembly in the receptacle body, a raiseable and lowerable top closure, and a sealing structure. The cutting subassembly includes at least three cutters having an associated blade facing upwards, with the cutters collectively arranged to define a pyramid having an apex, and puncture pin positioned at the apex to point upwardly. The spray nozzles are preferably arranged in a receptacle body for external and/or internal rinsing of the emptied bulk bag.

However, a disadvantage of this system is that it does not include a mechanism for fluidising the contents of the bag to allow easier removal of materials.

A further disadvantage of this invention is the method of fixing and supporting the cutters which remain in the fall zone of the powder/contents.

JP811322, JP2004323115 and JP20079921 also disclose cutting mechanisms where a bag is lowered, punctured and then cut with cutters which remain in a fall zone of the powder/contents.

Having the powder/contents fall through the knives which cut open the bag causes a number of major disadvantages. One is increased maintenance from the contents of the powder on the blades (especially in U.S. Pat. No. 6,293,318 where bulk bags containing particulate are hazardous materials). Secondly, these methods allow the powder to contact the outside of the bag, this has been handled and possibly subjected to dust contamination or pathogens which may then contaminate the powdered material.

Also, some automatic tipping stations require the installation of rotating parts in the fall zone of the powder. Again, there is increased maintenance caused when the powder enters moving parts of the device. The powder which comes in contact with (or is trapped) in the moving parts may contaminate the bulk power if it reenters the system.

These systems also lead to the generation of a large amount of dust that needs to be controlled. This dust can be detrimental to the health of people working in the vicinity; it can lead to loss of the powdered material into the environment or contamination of same.

It would therefore be beneficial to have an automated solution for discharging the powder from the plastic lined bags in which they are packaged, which overcomes the problems with existing methods, and ensures a sterile/hygienic product.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method for releasing flowable material via an automated means from a receptacle which has at least one closed end,

characterised by the steps of
a) locating the receptacle in a defined position relative to a receptacle opening mechanism, and
b) opening the receptacle with the receptacle opening mechanism,

the method characterised in that

the receptacle is positioned such that it is opened substantially at one end below the bulk of the material in the receptacle.

According to another aspect of the present invention there is provided apparatus for the release of flowable material from a receptacle which has at least one closed end,

the apparatus having

a locating mechanism for locating the receptacle in a defined position, and

a receptacle opening mechanism,

the apparatus characterised in that

the locating mechanism is configured to locate the receptacle with respect to the opening mechanism such that in operation the receptacle opening mechanism opens one end of the receptacle substantially below the bulk of the material in the receptacle.

Throughout the present specification the term flowable material should be understood to mean any material that is capable of being made to flow.

In a preferred embodiment of this invention, the flowable material is a powder, and shall be referred to as such herein.

Preferably, the flowable material is milk powder.

However, this should not be seen as limiting, as the term flowable material could include any other powdered or flowable material, for example: flour, sugar, fertiliser, pharmaceutical agents, chemicals, or liquids.

In a preferred embodiment of the present invention the receptacle is a bag and shall be referred to as such herein. For example, the bag may be a plastic bag such as that commonly used to hold milk powder.

However it should be appreciated that this is not a limitation on the present invention in any way and other receptacles are envisaged. Envisaged receptacles in other embodiments include, but are not limited to: sachets, re-closable plastic bags, intermediate flexible bulk containers, paper bags, or paper sacks.

In a preferred embodiment the defined position is within a sealed chamber, and shall be referred to as such herein.

The sealed chamber is designed to prevent the introduction of foreign matter into the powder, and to prevent the egress of powder from the apparatus and into the surroundings. This is necessary in cases such as in the food industry which contamination cannot be tolerated. However, this should not be seen as limiting as in other embodiments, such as the use of the present invention with a different flowable material, such as fertilizer, where the release of same may not be required to be within a sealed chamber, (however this may still be beneficial to the user's health).

The defined position of the bag in order to release the powder is such that the receptacle (bag) opening mechanism opens the bag substantially below the bulk of the material in the bag. This has the advantage that it allows the release of the bulk of the powder from the bag by gravity. This improves the efficiency of the invention, and minimises the retention of milk powder within creases, pockets or corners of the bag.

In a preferred embodiment of this invention the bag (receptacle) opening mechanism may be a sharpened serrated blade mounted horizontally between two support arms attached to a parallel horizontal radial actuator, and shall be referred to as a blade herein.

The support arms are spaced to allow the blade to rotate between the bag holding door and vice versa without interference.

However, it should be appreciated that other means of opening the bag are envisioned. These may include, but are not limited to, multi-bladed mechanisms, a shredding mechanism, serrated blade not on a radial actuator, or flying static knife on a linear actuator or flying rotating knife on a linear actuator.

When the bag is loaded into the chamber and it is detected to be in position against the bag holding door, the door opens to its first position to let the bag slide into the cutting position. This is achieved by engaging the first stroke of a dual stroke pneumatic cylinder used to rotate the bag holding door.

Vacuum pressure is then applied to the first vacuum plate mounted in the back of the chamber to engage the bag and hold it in position. At the same time the top vacuum plates are engaged, tapered spears, located centrally in the same housing are then extended piercing the bag.

The spears contain an annular series of holes near to the point of the spear that connect to a central air labyrinth. These holes extend into the bag allowing air to be injected into the bag with the taper effecting an air tight seal further up the spear. The bag is then able to be inflated to set pressure without leakage of air or powder.

The bag is now effectively ‘sandwiched’ against the back of the chamber and the top vacuum plates with the tapered spears and pressurised ready for cutting.

Inflation prior to cutting is essential for two reasons. Firstly, the air pressure expands the plastic and ensures that a high level of vacuum containment is achieved reducing vacuum leakage around the vacuum plates. This in turn ensures the bag is securely held by the vacuum plates when the bag holding door is opened fully to allow full discharge of powder to occur.

Secondly, inflation of the bag ensures the plastic is at the required tension for cutting. This is an important feature as a soft, saggy or crease filled bag could impact around a blade instead of being cut cleanly.

Once the pre-set levels of vacuum and pressure have been achieved, the first stage of a dual stroke cylinder attached to the knife is engaged and the bag is cut horizontally across the width of and underside end of the bag. This creates a flap of plastic at the end of the bag that is still attached to the top side of the bag.

After the stage one cut is made, the bag holding door opens to its maximum and the second stage of the blade actuator raises the blade further, cutting the bag through and lifting the blade with the cut plastic flap still attached to the top side of the bag above and away from the powder stream.

A significant advantage of this cutting mechanism is that it holds the cut flap of the bag up and away from the powder stream in a manner that allows the corner pockets of the flap to completely drain of powder without further assistance.

In preferred embodiments of the present invention the blade may be designed to cut the bag with a single action.

From pushing the blade into the bag the blade serrations join together to form a single cut. This is achieved through the force of upward pressure exerted by the radial actuator and may not necessarily be a swift sudden action but more of controlled sustained application of upward force.

The blade design of the present invention provides a significant advantage. The single incision limits shredding of the plastic bag which is often observed with multiple bladed devices, and therefore limits the potential for plastic to enter the powder. The design also ensures that the cut flap stays attached to rest of the bag.

In a preferred embodiment the blade is not removed from the bag during the release of the powdered material, but is raised above and out of the flow of powder effectively holding the cut plastic flap clear of the powder flow and preventing the flap impeding the powder flow while allowing the flap corners to drain by gravity or with air purge assistance.

In an alternative embodiment the blade may also contain a fluidisation port wherein compressed gas is introduced into the bag. This gas may be compressed sterile air or an inert gas such as nitrogen.

The fluidisation/introduction of air leads to increased powder yield and efficiency as powder is removed quickly from the corners and creases of the bag. This is especially the case as the blade is positioned under the majority of the material in the bag; powder will usually collect in the bottom corners of the bag and may not be released. Introducing air moves this powder out of the corners of the bag, wherein it can be released, increasing the efficiency of the process.

In an alternative embodiment the blade may be withdrawn to prevent it inhibiting or influencing the release of powder from the bag.

In a preferred embodiment the locating mechanism may be a pivoted portion, at the base of the sealed chamber which acts to position the bag in the defined position, and shall be referred to as such herein.

In a particularly preferred embodiment the location mechanism may be a radial pivoted flap.

However this should not be seen as limiting, as it should be appreciated that other locating mechanisms are envisaged, other embodiments envisaged include, but are not limited to mechanical linear stops, clamps, or vacuum pads.

In a preferred embodiment of the current invention the locating mechanism positions the bag in a defined position to enable the blade to cut each bag at approximately the same place.

During the emptying phase, the bag is supported solely by the vacuum plates with the bag opened fully at the end for maximum powder flow efficiency. The bag is securely held by the benefit of the initial bag inflation forcing the plastic on to the vacuum plates. After the bag has been cut, the internal bag pressure is relieved, and as the powder has been fluidised by the inflation process it flows and discharges easily. The injectors continue to inject air in to the powder during the emptying as a flow aid method and to clean powder form any crevice that may remain in the plastic.

In a preferred embodiment the pivoted portion links the first sealed containment chamber in which the bag is ‘opened’ and the powder released to a second chamber/powder receptacle. The pivoted portion effectively provides a demarcation point/air lock between the two chambers and allows only the minimum exposure of the cut bag end into the second chamber during the bag empty phase. The pivoted portion then seals during closure.

The advantage of this is that the tipped powder is not exposed to the chamber in which the bag is opened and is in a safe contaminant free sealed environment ready to be drawn away for further processing. This seal also prevents movement/formation of dust up into the first chamber where the full bags enter for opening.

A negative pressure system attached to the second chamber ensures displacement dust laden air does not flow back up into the first chamber during emptying the empty process.

At the completion of the emptying cycle and when the pivoted portion is closed, a blast of compressed air is pulsed into the first containment chamber. At the same time the empty bag extraction door is opened exposing the chamber to a high negative air flow. This combination effectively removes any minute residues of dust from the previous empty cycle along with the empty plastic bag.

The bag extraction door is connected to a duct that connects to:
A) A bag collection and discharge device.
B) A dust collector/filter housing.
C) A high pressure fan.

Following the powder empting process, the plastic bag is released from the vacuum plates top and bottom and the tapered spears are retracted. The pivoted portion (bag holding door) is closed, sealing the second chamber and the bag extraction door is opened.

The empty plastic bag is drawn through the bag extraction door into the extraction duct. The bag is conveyed by high negative pressure air flow through the duct to the bag discharge station where it is captured. The discharge station is fitted into the duct work prior to a dust collector. The dust collector effectively collects any dust residue which is entrained in the duct with the empty bag.

For discharging the bag, the duct air flow is isolated upstream of the discharge station and a valve at the bottom of the discharge station is opened. A plunger mechanism mounted above and opposite the opened valve is activated and expels the bag in to a rubbish receptacle. The plunger retracts and the bottom valve is closed. Duct air flow is then reinstated in preparation to receive the next bag.

In a preferred embodiment of the present invention there is provided a conveyer which utilises a tilting mechanism to position the bag inside the sealed chamber.

In one preferred embodiment the bag may be positioned within the chamber via the following:
a) the bag being moved onto a tilting platform by a conveyor belt,
b) the bag being held, or clamped in positing on the tilting platform,
c) the tilting platform being tilted, or tilted and lowered into the chamber at a controlled rate,
d) the chamber is sealed prior to the powder being released from same.

In a preferred embodiment the chamber may be on an angle between the horizontal and vertical. This provides the gravity to aid the powder release from the bag while maintaining some weight bearing which would not be present if the bag were vertical.

In a preferred embodiment the chamber may be approximately 50-70° from the horizontal. However this should not be seen as limiting as other angles may also be utilised with the present invention.

In a preferred embodiment the bag may be lowered into the chamber until it contacts the pivoted portion. This positions the bag correctly for opening same.

In a preferred embodiment when the bag is in the correct position it may be secured to maintain it in the correct position during release of the powder.

In a preferred embodiment the bag may be secured via a tensioning device. This may be a vacuum panel or apparatus, however this should not be seen as limiting as other securing devices/means may be utilised to secure the bag in position.

In one preferred embodiment the tensioning device may be an annular vacuum grip assembly and shall be referred to as such herein. Throughout this specification an annular vacuum grip assembly may be taken as meaning a substantially circular or ring shaped device which is positioned such that when a vacuum is applied forms a seal with and holds/tensions the bag when in the correct position.

In a preferred embodiment the bag may be secured against the side of the chamber closest to the horizontal (i.e. the side angled approximately 50-70° from the horizontal).

In a preferred embodiment the sides of the bag may be held apart (be under lateral tension) during the release of the powder. This aids in the release of all the powder by opening up the bag and decreasing the creases which may result as the bag empties.

Throughout this specification the term lateral should be taken as meaning any of the longitudinal sides of a bag, even if the bag is not in a vertical position. The term lateral tension should be taken as meaning tensioning or stretching the sides of the bag away from one another to open up the inside of same.

In a preferred embodiment the lateral tension may be provided by one vacuum gripping pad (or vacuum grip assembly) on the substantially opposing side of the bag to the securing (tensioning) device, and shall be referred to as such. However this should herein not be seen as limiting as any other attachment means may provide same.

In one preferred embodiment there may be two vacuum grip pads to provide lateral tension from the side of the bag opposing the securing (tensioning) device.

In one preferred embodiment the lateral tension may be provided by an annular vacuum grip assembly.

According to another aspect of the present invention there is provided a method for releasing flowable material via an automated means from a receptacle which has at least one closed end,

characterised by the steps of
a) locating the receptacle in a defined position relative to a receptacle opening mechanism, and
b) opening the receptacle with the receptacle opening mechanism,
c) fluidising the flowable material within the receptacle.

According to another aspect of the present invention there is provided an automated apparatus for the release of flowable material from a receptacle which has at least one closed end,

the apparatus having

a locating mechanism for locating the receptacle in a defined position,

a receptacle opening mechanism,

a mechanism to fluidise the flowable material within the receptacle.

Reference throughout this specification shall now be in relation to an apparatus and method which combines fluidising with cutting the receptacle substantially below the contents of the receptacle which has at least one closed end.

In one embodiment the opening mechanism (blade) may have a fluidisation port attached to same. This may be used to inject air into the bag once the incision has been made. This prevents powder being retained in the lower corners of the bag. In this instance the blade would stay in the cutting position while the powder is released from the bag.

Fluidisation results in separating the powder from the bag and breaking up ‘lumps’ of powder. This aids in the release of the powder from the bag.

In a preferred embodiment of the current invention powder may be fluidised by the introduction of gas into the bag and shall be referred to as such herein. However, this should not be seen as limiting as other methods of fluidising the powder within the bag could be utilised, these include, but are not limited to, ultrasonic agitation, a mechanical means of vibration or as agitation, or injection of various gases including air, nitrogen, argon or carbon dioxide.

In a preferred embodiment the gas may be pressurised prior to fluidisation, and shall be referred to as such herein, however, this should not be seen as limiting as non-pressurised gas may also be utilized with the present invention.

In a preferred embodiment the gas is air, and shall be referred to as such herein.

However, this should not be seen as limiting as any other inert or suitable gas may be utilised with the present invention.

In a preferred embodiment, for use with food products such as milk powder, food grade air would be used.

In a preferred embodiment the pressurised air may be introduced into the bag via a hollow connecting device. The hollow connecting device will herein be referred to as a spear.

In a preferred embodiment the spear may be the central portion of a vacuum (or other) grip assembly which provides lateral tension to the bag.

In order to ensure that powder is not lost from the bag during emptying (especially when fluidisation is used) the bag must be stably sealed around the spear. When the spear is used in conjunction with an annular vacuum grip assembly the vacuum ring helps provide the required seal around the spear.

A number of forces are at work on the bag during the emptying process. Due to the mass of powder emptying out of the bag under gravity, a plastic bag may be pulled or stretched against the spear and break the seal.

In a preferred embodiment the spear may be tapered towards the end which pierces the bag. This taper leads to a self sealing action on the plastic bag as it is pierced. This sealing action is facilitated by the properties of the particular plastic materials that are commonly used in powder bags (such as those used to hold milk powder) being polyethylene barrier film.

This sealing action is important to ensure that the air and powder can only exit the bag through the opened end.

The tapered shape of the spear forces the plastic to expand and create an air tight seal around the taper.

The use of a tapered spear is not intended to be restrictive on the means of introducing air to the bag. Other means including, but limited to, a non tapered spear, multiple tapered spears, or multiple non tapered spears are envisaged.

In a preferred embodiment the spear may have at least one capillary at the end which pierces the bag. The capillaries act to allow pressurised air to be injected into the bag.

Having at least one capillary in the tapered spear allow direct injection of air into the bag after a seal has been formed. The direct injection of pressurised air has the advantage of minimising loss of powder from the bag, and means injection of air and piercing the bag can be performed as a single step.

However it is envisaged that in other embodiments of the invention other methods for injecting air into the bag after cutting the bag are possible. These may include, but are not limited to, a probe mechanism subsequent to cutting of the bag being inserted through the cut with subsequent air injection or removal of powder by vacuum.

In a preferred embodiment the capillaries may be drilled into the end of the spear However this should not be seen as limiting as the pressurised air may be supplied in other ways such as an inserted nozzle or capillaries formed by other methods.

In a preferred embodiment of the invention fluidisation of the powder occurs prior to opening of the bag. However this should not be seen as limiting, as fluidisation could also, or instead occur after opening of the bag and egress of the powder has started.

In a preferred embodiment of the current invention the bag is placed under lateral tension to assist fluidising and releasing the milk powder from the bag. However it is envisioned that fluidising milk powder within a bag could occur without the application of this lateral tension.

The application of positive pressure via injection of air into the bag acts to remove any creases from the bag prior to cutting which could potentially hinder the release of powder and to ensure efficient fluidisation of the milk powder.

In a preferred embodiment of the current invention lateral tension is applied to the bag prior to piercing the bag with the tapered spear. Preferably this may be achieved using an annular vacuum grip apparatus. In a particular embodiment the lateral tension may be provide by at least two annular vacuum grip apparatus on substantially opposing sides of the bag acting as a securing (tensioning) device and providing lateral tension.

In a preferred embodiment the spear may pierce the bag from within the diameter of one (or more of) the annular vacuum grip assembly. However, this should not bee seen as limiting as the bag may be pierced in other positions with the present invention.

In a preferred embodiment the spear is present and introduced into the bag from the annular vacuum grip assembly which is on the upper side of the bag when on an angle. In this instance the securing (tensioning) device does not house any fluidising spear.

The self sealing action of the lateral spear is reinforced by the use of vacuum gripping pads on opposing sides of the bag which act to apply lateral tension to the bag. The combination of the positive pressure, tapered spear, lateral tension, and the type of plastic commonly used in these bags, acts to enhance the air tight seal and prevent the loss of milk powder into the surrounding environment.

However other means of applying tension to the bag are envisaged and include, but are not limited, to mechanical grippers. It is also possible that fluidisation of milk powder could occur without this lateral tension being applied to the bag.

In the preferred embodiment of the current invention the bag is cut by the blade after the application of positive pressure. This allows full benefit of the fluidisation of the milk powder to be gained. These benefits include an increased yield of released milk powder from the bag and minimises entry of foreign matter into the milk powder.

In a preferred embodiment, fluidisation is provided via the spear before the bag is cut open, then after the bag is cut and the bag pressure has been released, further air is introduced from the spears, at a higher pressure than for inflation, to further fluidise and speed the evacuation of powder from the bag.

Air introduced through ports on the blade help ensure that all powder has been removed from the bag, included that which has collected in the bottom corners. This increases the efficiency of the process and results in the highest yield possible without the requirement for human contact with the bag or movement of same.

In a preferred embodiment once the powder has been released from the bag the pivoting portion closes to protect the released powder.

In a preferred embodiment the bag is then released and may be removed from the chamber by a vacuum extraction, or other system.

In a preferred embodiment there is a bag removal assembly on one side of the chamber. Once a bag has been emptied the removal assembly opens an orifice and a vacuum is applied which sucks the bag out of the chamber and into the bag removal assembly.

In one preferred embodiment the bag removal assembly consists of a flush mounted slide assembly on the side of the chamber that opens to 150×300 mm orifice. A transition mounted on the other side is connected to a 150 mm duct and to a high pressure fan with a discharge station inline prior to the fan inlet. When the bag has completed the discharge, the slide is opened and the bag is released into a high velocity negative air stream which sucks the bag through the duct work to the discharge station. The slide closes and the machine is ready for the next cycle. A series of filters in a dust collector housing after the located after the discharge station removes any powder traces from the air extracted from the chamber.

The current invention has significant advantages over existing methods of emptying bags, these include the following:
It decreases the amount of manual labour required, this is provided by the automated positioning of the bag within the apparatus, cutting open and emptying same and removal of the empty bag.
It eliminates the possibility of contamination from operators opening and emptying bags, by emptying same within a sealed chamber.
The sealed chamber also allows any dust of the powdered material to be collected.
The cutting means combined with the tensioning devices and fluidisation ensures that all the powder is released from the bag. This is a significant advantage, especially where the powder is high value or a large number of bags are being emptied.

### BRIEF DESCRIPTION OF DRAWINGS

Further aspects of the present invention will become apparent from the following description, which is given by way of example only and with reference to the accompanying drawings in which;

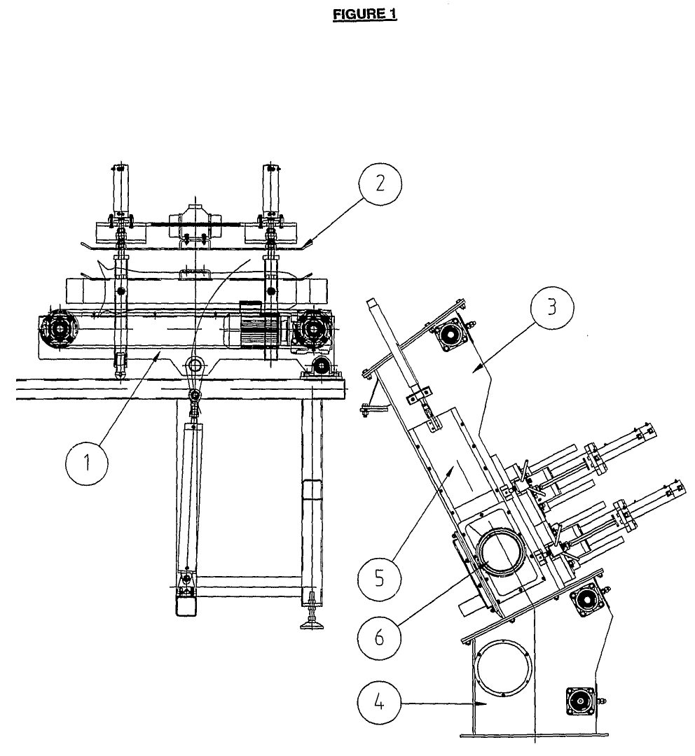

FIG. 1 is a diagrammatical representation of an overall view of the present invention with numbering;
1. Bag Infeed Conveyor
2. Bag Clamping Plate
3. Main Chamber
4. Secondary Chamber
5. Empty Bag Ejection Gate
6. Empty Bag Transition Duct

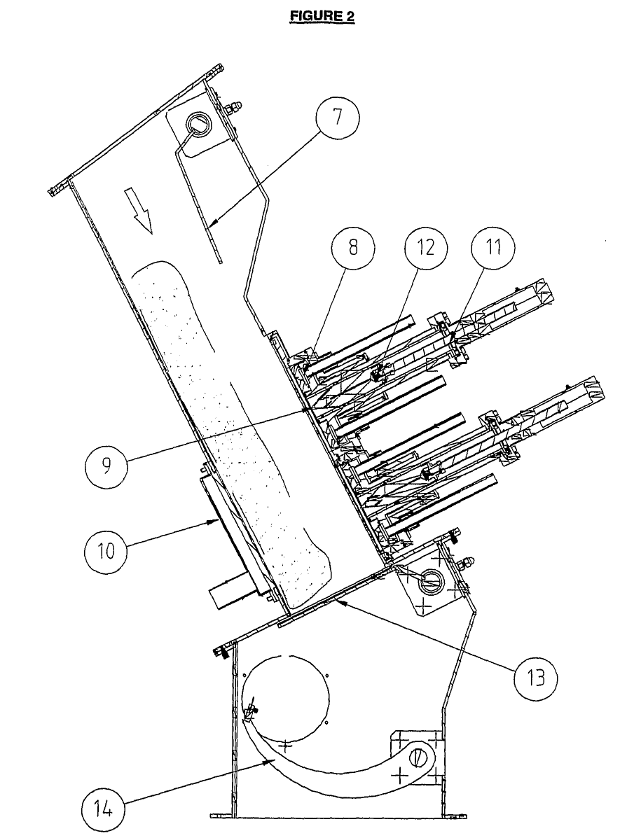

FIG. 2 is a diagrammatical representation of an enlarged side view of the present invention with numbering;
7. Bag Entry Door
8. Top Vacuum Head
9. Air Injection Spear
10. Bottom Vacuum Plate
11. Air Injection Capillary
12. Vacuum Inlet Supply Tube
13. Bag Holding Door
14. Radial Knife

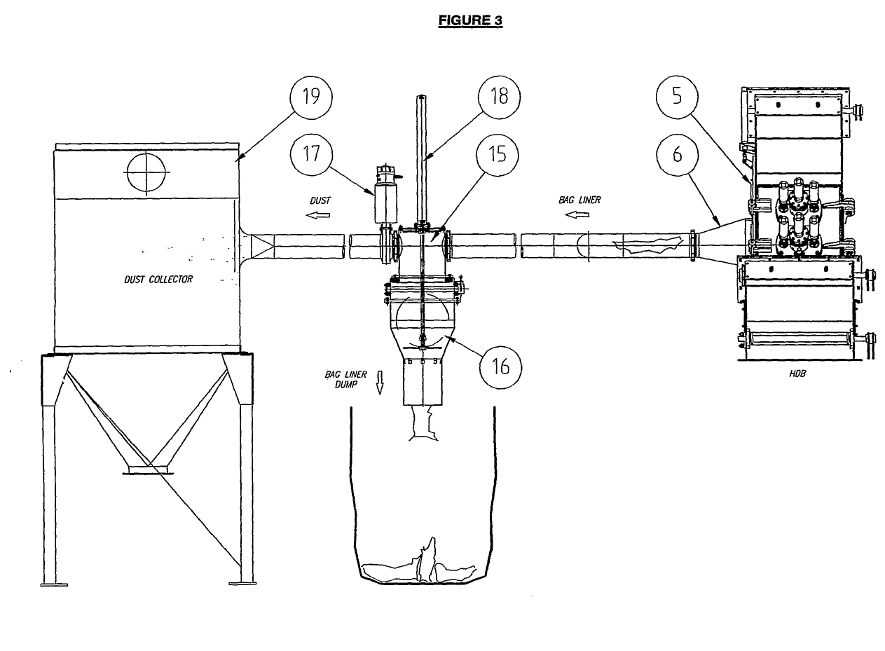

FIG. 3 is a diagrammatical representation of the bag disposal apparatus with numbering;
15. Empty Bag Receiver
16. Empty Bag Ejection Flap
17. Bag Extraction Air Isolation Valve
18. Empty Bag Ejection Plunger
19. Dust Collection Vessel

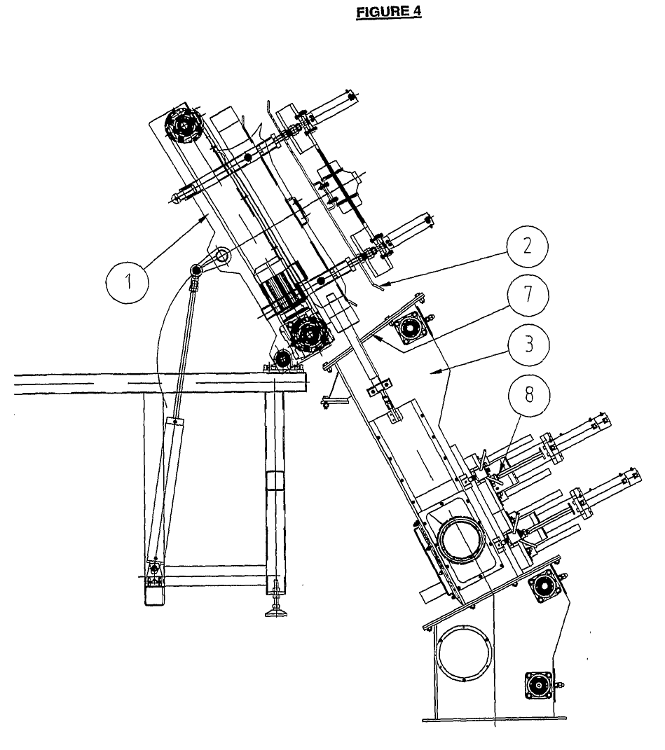

The following FIGS. 4 to 11 show a diagrammatic representation with numbering of various stages of one aspect of the present invention in operation;

FIG. 4 Stage 1—infeed Conveyor
1. Bag Infeed Conveyor—Raised
2. Bag Clamping Plate—Raised
7. Bag Entry Door—Open
8. Top Vacuum Heads—Retracted

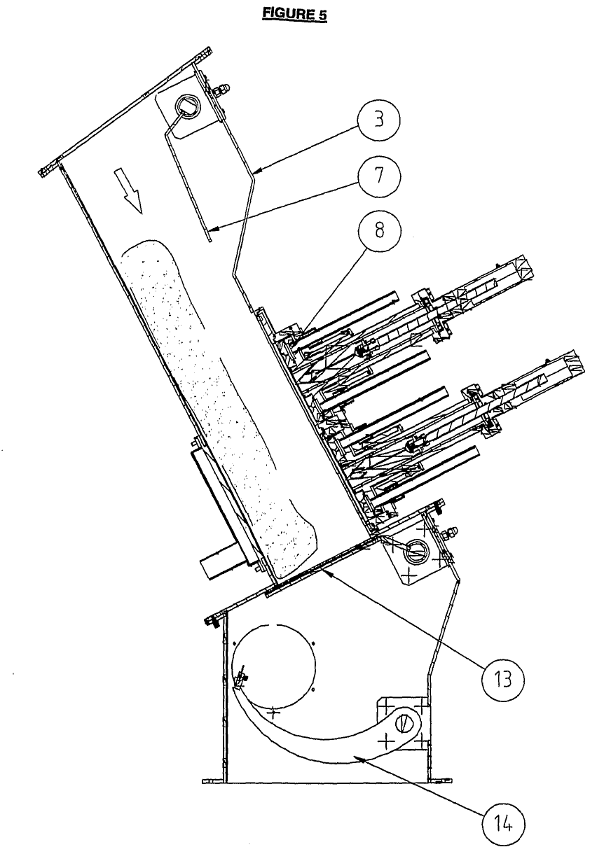

FIG. 5 Stage 2—Bag Entry
7. Bag Entry Door—Open
8. Top Vacuum Heads—Retracted
13. Bag Holding Door—Closed
14. Radial Knife—Retracted

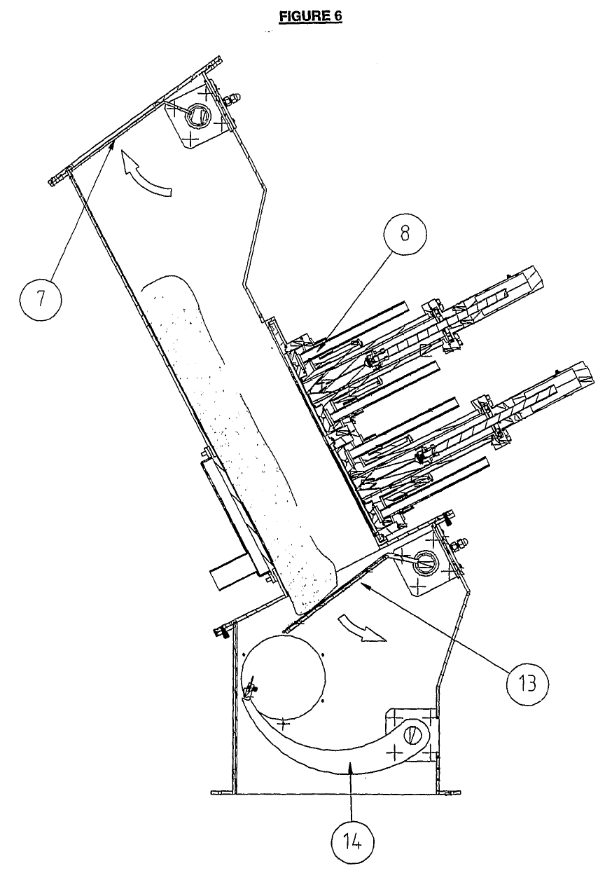

FIG. 6 Stage 3—Bag Positioned
7. Bag Entry Door—Closed
8. Top Vacuum Heads—Retracted
13. Bag Holding Door—Open to stage one
14. Radial Knife—Retracted

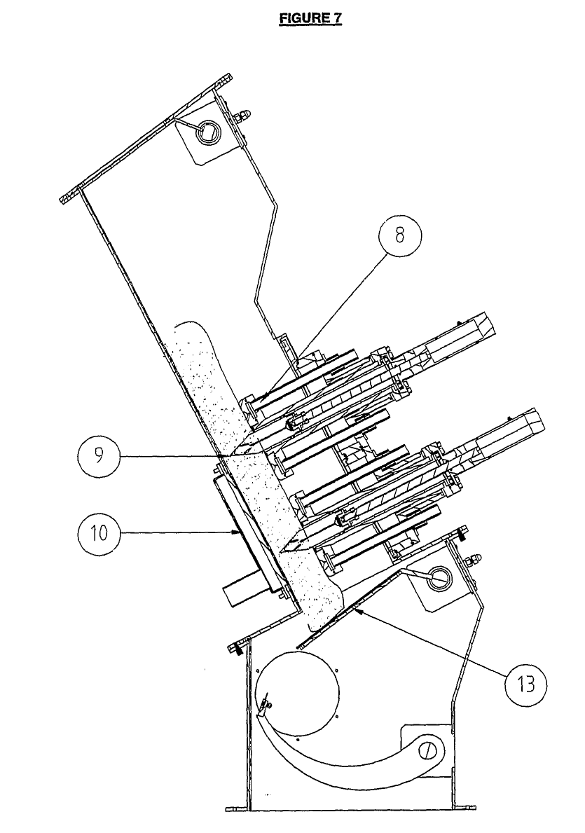

FIG. 7 Stage 4—Spear Entry
13. Bag Holding Door—Open to stage one
10. Bottom Vacuum Plate—Vacuum applied
8. Top Vacuum Head—Extended
12. Vacuum Inlet Supply Tube—Vacuum applied
9. Air Injection Spear—Extended

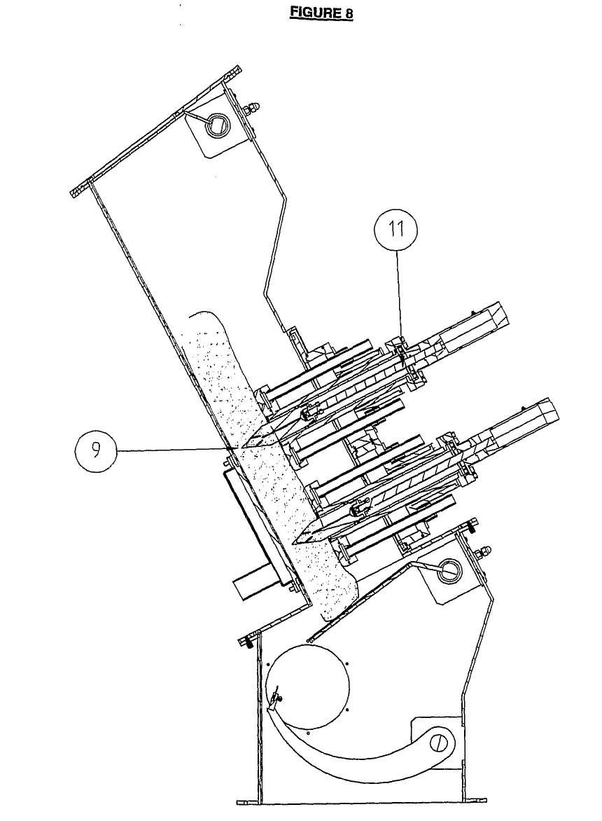

FIG. 8 Stage 5—Bag Inflate
9. Air Injection Spear—Extended
11. Air Injection Capillary—Air pressure applied

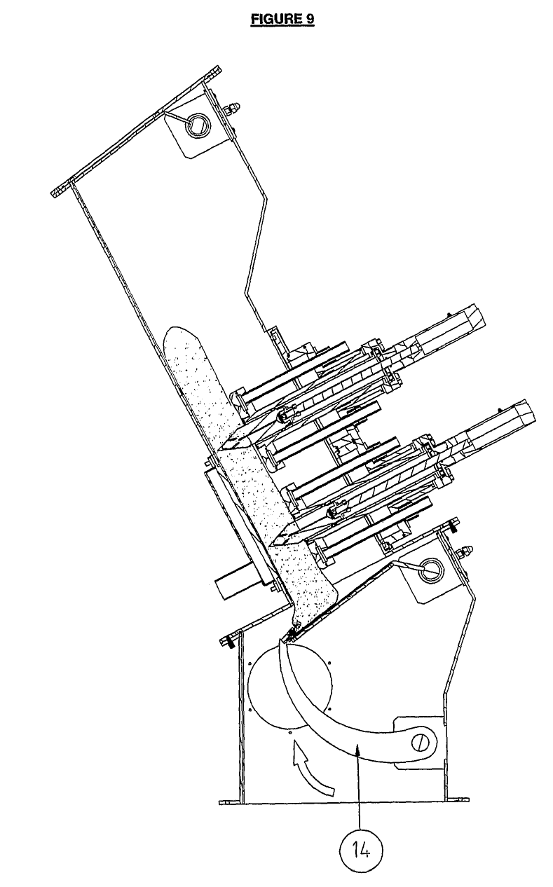

FIG. 9 Stage 6—Bag Cut
14. Radial Knife—Rotates to stage 1 position

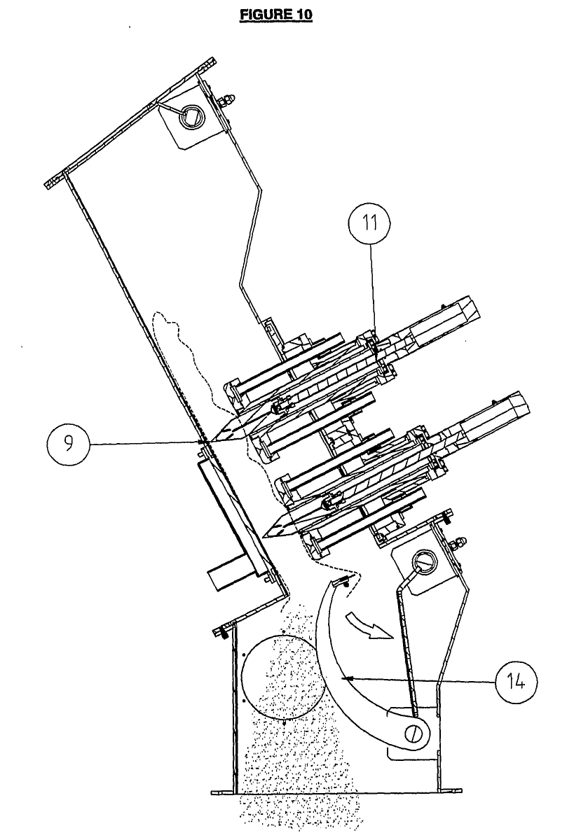

FIG. 10 Stage 7—Bag Emptying
14. Radial Knife—Rotates to stage 2 position
9. Air Injection Spears—Extended
11. Air Injection Capillary—Air is injected at volume

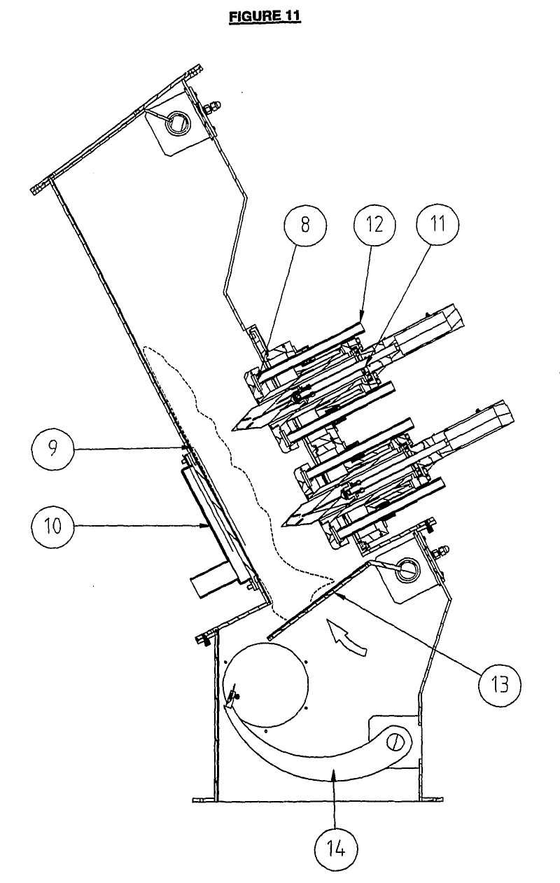

FIG. 11 Stage 8—Empty Bag Ejection
8. Top Vacuum Head—Retracted
9. Air Injection Spears—Retracted
10. Bottom Vacuum Plate—Vacuum off
11. Air Injection Capillary—Air off
12. Vacuum Inlet Supply Tube—Vacuum off
13. Bag Holding Door—Open to stage one
14. Radial Knife—Retracted

### BEST MODES FOR CARRYING OUT THE INVENTION

With reference to the figures above, the first section is a bag infeed conveyor (1) which moves the bag onto a bag clamping plate (2). The bag clamp plate is lowered while the conveyor is tilted in position. The bag clamp plate (2) is raised and with the bag entry door open (7), the bag is fed into the main chamber (3).

The chamber (3) is sealed and is designed to prevent the introduction of foreign matter into the flowable material. Entry to the sealed chamber (3) is by way of an entry door (7).

Once the bag is in the sealed chamber (3), the entry door (7) will close. Beneath the bag is a bag holding door (13). This bag holding door (13) serves a two fold purpose. Firstly, in the closed position the flap supports the bag as it moves into position. Secondly, the bag holding door (13) in the open position serves as a control point to prevent the back flow of milk powder into the sealed chamber (3).

Once the receptacle is in position, a vacuum is applied to both faces of the bag and held in tension by a bottom vacuum plate (10) and top vacuum head (8). The vacuum is supplied by a vacuum inlet supply tube (12).

Positive pressure is applied to the bag using an air injection tapered spear (9). This positive pressure is applied using an air supply through air injection capillaries (11) at the end of the tapered spear (9).

The tapered spears (9) penetrate through the plastic and are designed to produce a self sealing action on the bag as it is pierced and it also inflates the bag.

The pressure inside the bag will be monitored and air injection capillaries (11) within the tapered spear (9) will close when a preset differential pressure within the bag has been achieved.

Once the pressure differential has been met, the bag is opened using a radial knife (14) which rotates to the stage 1 position. The radial knife is actuated and cuts the base of the inflated bag. The bag is opened such that the contents are substantially above the opening. The contents of the bag (e.g. powder) are discharged into the secondary chamber (4) with air injected to assist the powder flow. This also acts to remove any material which has collected in the bottom corners of the bag while it has emptied.

Once the receptacle is empty, the bag holding door (13) will close to seal the chamber (3) and prevent the introduction of foreign matter.

When the bag is empty, the bag is ejected through a gate (5) and transition duct (6) and is removed from the chamber (3) using a negative pressure system which extracts the empty bag. This system includes an empty bag receiver (15), empty bag ejection flap (16), a bag extraction air isolation valve (17), an empty bag ejection plunger (18) and dust collection vessel (19).

The empty bag will be collected in a low pressure ‘drop out’ vessel for disposal or conveyed for automatic compaction.

Aspects of the present invention have been described by way of example only and it should be appreciated that modifications and additions may be made thereto without departing from the scope of the appended claims.

1. A method for releasing flowable material via an automated means from a receptacle which has at least one closed end, comprising the steps of:
a) locating the receptacle in a defined position relative to a receptacle opening mechanism, and
b) opening the receptacle with the receptacle opening mechanism,
wherein fluidization of the flowable material within the receptacle is initiated before opening of the receptacle.

2. A method as claimed in claim 1 wherein the receptacle is a bag.

3. A method or apparatus as claimed in claim 1 wherein the defined position is within a sealed chamber

4. A method as claimed in claim 1 wherein the receptacle is at an angle between horizontal and vertical when in the defined position.

5. A method as claimed in claim 1 wherein the sides of the receptacle are under lateral tension.

6. A method as claimed in claim 5 wherein the lateral tension is supplied by vacuum apparatus on substantially opposing sides of the receptacle.

7. A method as claimed in claim 1 wherein the receptacle is positioned such that it is opened substantially below the bulk of the material in the receptacle.

8. A method as claimed in claim 1 wherein fluidization is performed via the introduction of pressurized gas into the receptacle.

9. A method as claimed in claim 1 wherein fluidization is via the introduction of pressurized gas into the receptacle after the receptacle is tensioned.

10. A method as claimed in claim 1 wherein fluidization is continued after the receptacle is opened.

11. A method as claimed in claim 8 wherein pressurized gas is introduced via a fluidization port on a cutting blade.

12. A method as claimed in claim 8 wherein pressurized gas is introduced via a spear.

13. A method as claimed in claim 12 wherein the spear is tapered.

14. A method as claimed in claim 12 which includes an annular array of vacuum ports around the spear.

15. An apparatus for the release of flowable material from a receptacle which has at least one closed end, the apparatus having
a locating mechanism for locating the receptacle in a defined position,
a receptacle opening mechanism, and
a mechanism configured to fluidize the flowable material within the receptacle prior to opening the receptacle.

16. An apparatus as claimed in claim 15 which includes a sealed chamber.

17. An apparatus as claimed in claim 15 wherein the receptacle is between at an angle to the horizontal and the vertical when in the defined position.

18. An apparatus as claimed in claim 15 which also includes a tensioning device to secure the receptacle in the correct position during release of the flowable material.

19. An apparatus as claimed in claim 18 wherein the tensioning device is one vacuum apparatus.

20. An apparatus as claimed in claim 15 which also includes at least one device to apply lateral tension to the sides of the receptacle prior to the release of the flowable material.

21. An apparatus as claimed in claim 20 wherein the device to apply lateral tension is vacuum apparatus on substantially opposing sides of the receptacle.

22. An apparatus as claimed in claim 15 wherein mechanism to fluidize the flowable material is configured to introduce pressurized gas into the receptacle.

23. An apparatus as claimed in claim 15 wherein mechanism to fluidize the flowable material is configured to introduce pressurized gas into the receptacle after the receptacle is tensioned.

24. An apparatus as claimed in claim 15 wherein the mechanism to fluidize the flowable material is configured to continue to provide pressurized gas to the receptacle after the receptacle is opened.

25. An apparatus as claimed in claim 15 wherein the mechanism to fluidize the flowable material is a fluidization port associated with a cutting blade.

26. An apparatus as claimed in claim 15 wherein the mechanism to fluidize the flowable material is a spear.

27. An apparatus as claimed in claim 26 wherein the spear is tapered.

28. An apparatus as claimed in claim 26 which includes an annular array of vacuum ports around the spear.

29. An apparatus as claimed in claim 15 wherein the receptacle is positioned such that it is opened substantially below the bulk of the material in the receptacle.

30. (canceled)

31. (canceled)
